(19) United States
(12) Patent Application Publication
(10) Pub. No.: US 2005/0179774 A1
(43) Pub. Date: Aug. 18, 2005

(54) BASECAM: a system for using a camera within a baseball base

(76) Inventors: Whitney Fletcher, San Carlos, CA (US); Kent Fletcher, Pearl City, HI (US)

Correspondence Address: Whitney Fletcher, 1349 Cordelleris Ave, San Carlos, CA, 94070, US

(21) Appl. No.: 10/777,689

(22) Filed: Feb. 13, 2004

(51) Int. Cl. H04N 7/18

(52) U.S. Cl. 348/61

(57) ABSTRACT

A camera and transmitter are mounted within a baseball base such that they do not interfere with the baseball game. The camera gathers images and the transmitter sends the video signal to a receiver. The receiver communicates the video signal to an editing board which can insert the images into a television or internet broadcast.

### BACKGROUND OF THE INVENTION

1. Field of the Invention

The present invention is directed to a system using a camera in an object at a sporting event.

2. Description of the Related Art

When viewing a sporting event on television or on the internet, it is advantageous to the viewer if the television or internet broadcaster has at its disposal as many different camera positions as possible. By placing a camera, or multiple cameras, within the bases used in a baseball game, viewers will enjoy a greater variety of camera positions and will be able to view certain plays from an angle never before seen. If broadcasters can make their broadcast of the game more compelling, viewers will be less likely to turn off the television, change channels, go to a different website or focus their attention elsewhere. Thus there is a need to provide a greater variety of camera positions so viewers will enjoy the game more.

Other attempts to broadcast images from the playing field have included embedding cameras within the equipment or uniforms of players or officials on the field. These cameras, however, do not provide a steady image due to the movement of the player or official, and the uncertainty of the camera position making it impossible for the broadcaster to reliably predict where the camera will be at any given moment.

Currently, television or Internet broadcasters position cameras around the perimeter of the playing field, these cameras are limited by the nature of their positions.

Putting cameras directly within the field of play will provide new and unique views of the game.

Thus, there is a need for a system that uses cameras within the playing field, that does not interfere with the play or view of the game, and that can reliably gather and transmit quality images from within the playing field.

### SUMMARY OF THE INVENTION

The present invention is directed to overcome the disadvantages of the prior art. Thus, the present invention provides for a system for using a camera, or multiple cameras, with a baseball base. Baseball is a sport thought to be invented in the United States of America and is played on the professional, amateur and collegiate level throughout the world. In baseball three bases are utilized (first base, second base, third base) and a fourth base called home plate. Home plate differs in design from the other three bases. First, second and third bases are made of a square padded object anchored to the playing field. They serve as focal points for players during the game. In this invention the camera is located within the base. Placing the camera in the base prevents the camera from being damaged due to the compression of the base when the base is stepped on, slid into or otherwise contacted by a player or piece of equipment. The camera is also protected from damage by placing it within a hardened material. In one embodiment the hardened material is ABS plastic.

The baseball base includes a shell, a pad inside the shell and a baseplate. The port that the camera fits into is in the shell and continues into the pad. The system also includes a transmitter that is connected to the camera. In one embodiment, the system includes a cavity within the base. The transmitter and all related components are housed within the cavity such that all are protected from moisture and dust.

In one embodiment it is contemplated that a system utilizing compressed gas would be integrated into the base to allow the clearing of dirt or other debris from the front of the camera lenses.

In one embodiment it is contemplated that a system that closes a cover over the camera lenses when they are not actively recording images, would be utilized.

It is contemplated that the cameras used may be equipped with zoom lenses and/or pan and tilt capability, controlled by a technician by R/F radio remote control or by a hardwired system.

In one embodiment it is contemplated that the system may be hardwired via a network of wires and cables, hoses and/or fiber optic cables buried beneath the playing surface of the field, making the need for the wireless transmitted components unnecessary. In this embodiment the bases are all connected to a video capture board by the buried cables, with the video capture board removed from the field of play and out of view of the players or spectators.

It is contemplated that during a baseball game three bases could utilize the principles of the present invention (first base, second base and third base). In one embodiment, each base transmits an RF signal at a different frequency. The transmitter frequencies are selectable from a predetermined set of frequencies. Multiple cameras would be housed in the same base to provide a greater variety of camera positions or fields of view. The transmitter in each base is capable of relaying multiple signals at the same time to a video capture board which can be used to choose which, if any, of the video signals are to be inserted into the broadcast signal for a television/internet broadcast. It is further contemplated that additional cameras could be placed within the field in the pitcher's mound, home plate, the dirt area between the edge of the outfield grass (or artificial turf) and the fence or wall which defines the outfield (warning track), in the grass or turf area between the infield and the outer edge of the field (the outfield) in the grass or turf area of the infield or in the area between the foul lines and the fence or walls which define the outer edge of the foul territory of a baseball field.

These and other objects and advantages of the invention will appear more clearly from the following description in which the invention has been set forth in conjunction with the drawings

### BRIEF DESCRIPTION OF THE DRAWINGS

FIG. 1 depicts a perspective view of a baseball base according to the present invention.

FIG. 2 is a bottom view of the baseball base of FIG. 1.

FIG. 3 is a top view of the baseball base of FIG. 1.

### DETAILED DESCRIPTION OF THE DRAWINGS

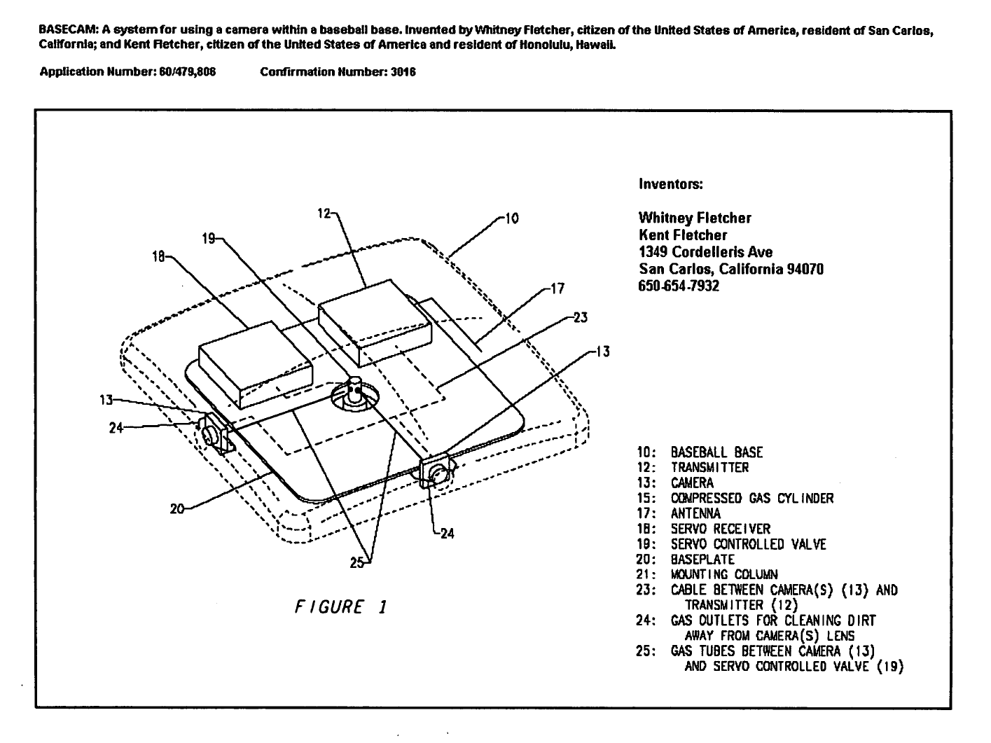

FIG. 1 shows a baseball base (10) that utilizes the current invention. Base (10) can be used as first base, second base or third base. It is also contemplated that the principles of the current invention could be used with a pitcher's mound, home plate or other object on the field at a sporting event. Base (10), which is of the standard dimensions and feel of a regulation baseball base, includes a base body having a top surface, a bottom surface and four side surfaces.

Mounted inside base (10) is a wireless transmitter (12). In the disclosed embodiment, transmitter (12) is an RF transmitter. Transmitters that utilize other spectra are also within the spirit of the present invention. Batteries power transmitter (12). In the embodiment of FIG. 1-3, transmitter (12) is completely encased by base (10). One example of a suitable transmitter for this application is the MVL33 (four channel) sold by Supercircuits of Liberty Hill, Tex., USA. The frequency range of the MVL33 is 2.410 to 2.470 GHz. Other transmitters broadcasting at other frequencies could be used.

Transmitter (12) connects to antenna (17), which is a whip antenna. Antenna (17) extends into base (10). Other antennae that fit unobtrusively within base (10) can also be used; for example, a flat mesh antenna, a ribbon style antenna, a dipole antenna made from flexible material and other antennae can be used. The inventors contemplate that alternative transmitters may not use an external antenna.

Transmitter (12) connects to camera (13). Camera (13) is a miniature high quality color video camera. One example of a suitable camera is the MVL33 sold by Supercircuits of Liberty Hill, Tex., USA. Camera (13) is mounted to so that the front of camera (13) is flush with side or top of base (10). In one embodiment, camera (13) can be mounted in a slightly recessed position. Preferably, the housing of camera (13) is the same color as the surface of base (10). It is contemplated that a high quality clear lens cover could be used to protect the exposed surface of camera (13). It is contemplated that camera (13) could have zoom (adjustable focal length) lens, pan/tilt capability, and/or manual/auto focus capability.

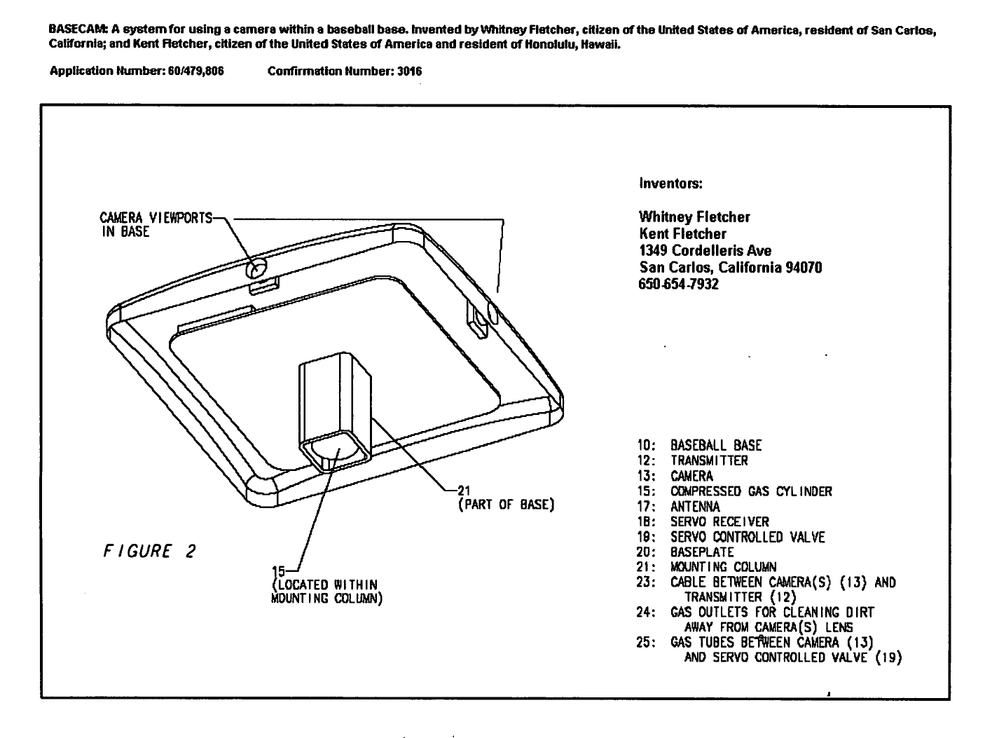

Compressed Gas Cylinder (15) is mounted within Mounting Column 21 (FIG. 2). Servo Controlled Valve (19) is attached to the top of Compressed Gas Cylinder 15 and to Servo Receiver (18). A suitable servo and servo receiver is the FBS14B and the FP-R127DF made by Futaba Corporation of Japan. A suitable R/C (radio controlled) controller for the server is FPT6NFK by Futaba of Japan. Other types of servo/receivers/controllers could be used. It is contemplated that in one embodiment the compressed gas valve would be controlled from off the playing field via a system of cables buried under the ground. Gas Tubes (25) are connected to Valve (19) and to Gas Outlets (24). Valve (19) is designed to direct compressed gas onto the camera lens to clear the lens of any dirt or debris that might obstruct the view of camera (13). Tubes (19) are common flexible plastic. A suitable type of compressed gas being Dust-Off brand. It is contemplated that in one embodiment the compressed gas would be delivered to the base from off the playing field via a system of pipes/tubes buried under the ground and a mechanical air compressor fitted with a suitable air filtration system.

FIG. 2 is a bottom view of base (10) that shows how the components are mounted in base (10). The interior of base (10) is made of a foam compound. Inside base (10) is a cavity. This cavity is open at its bottom so that if base (10) is turned upside down, the cavity can be accessed by removing baseplate (20). Baseplate (20) is a metal plate that has four sides, a top and a mounting column (21) attached to its center point at a perpendicular angle to baseplate (20). This mounting column fits into a receptacle buried in the ground and is what holds the entire base (10) in place and correctly oriented to the field of play. Base (10), baseplate (20), mounting column (21) and the receptacle, which the mounting column fits into, are parts of the existing professional baseball base.

Transmitter (12) is mounted within the cavity and covered by the baseplate (20). Suitable foam rubber padding is envisioned by the inventor to prevent damage to the transmitter. The baseplate (20) is attached to base (10) by means of screws.

Compressed Gas Cylinder (15) is mounted within Mounting Column (21). Servo Controlled Valve (19) is attached to the top of (15) and to Servo Receiver (18). Gas Tubes (25) are connected to (19) and to Gas Outlets (24). Gas Outlets (24) are positioned so they will clear debris from in front of Camera(s) (13).

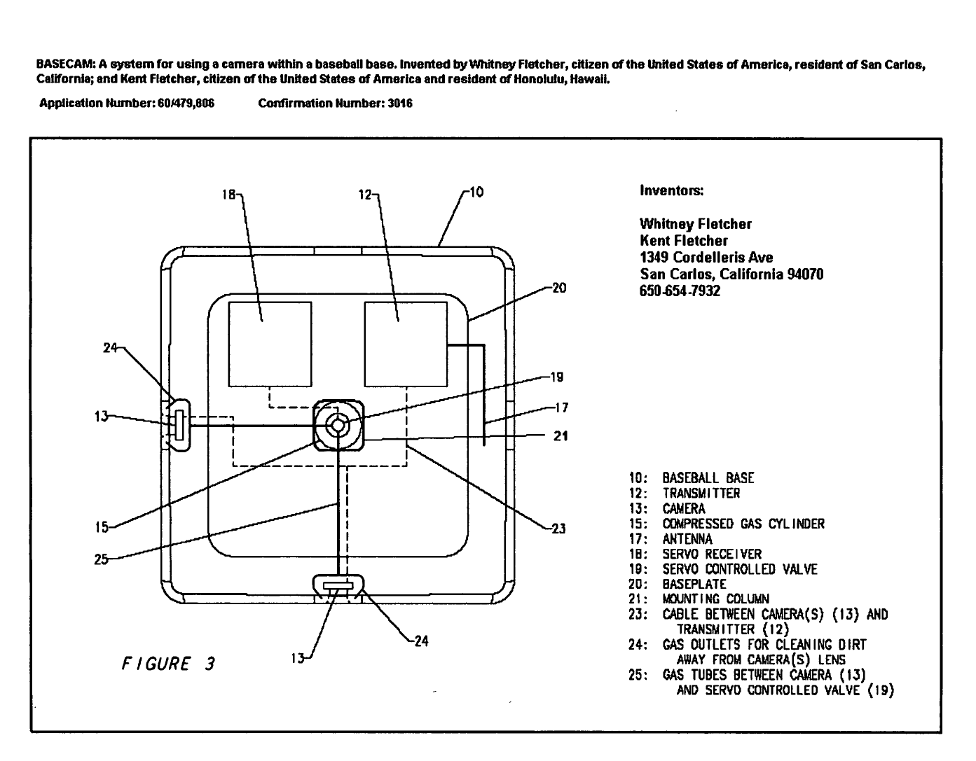

FIG. 3 is a bottom view of the baseball base with the components of a two camera system installed.

A visible outside surface is defined as the portions of the outside surface that are visible when the base is installed on the playing field. When base (10) is installed on a playing field, the mounting post is in the ground and the bottom surface is not visible, The only outside surfaces that are visible when base (10) is installed in the ground are the side surfaces and top surface. When properly installed, Basecam will not interfere with the feel, function or appearance of a baseball base.

The system can be used in conjunction with television or Internet broadcasts during a baseball game. During the game, a video camera will gather images from the field of play. The video signal from the camera is sent by a transmitter, or by a hardwired system, to one of the receivers, which passes the signal to a video board. An operator of the video board can choose to ignore or use the video signal from a particular camera. For example, if the operator can see that there is not action near third base. Then the operator may choose to ignore any signal from the cameras inside third base. Since the camera and transmitter are housed within the base, they do not protrude from a visible surface of the base, and do not alter the size, shape or feel of the base, and so there is no distraction to the players or fans at the stadium.

The foregoing detailed description of the invention has been presented for purposes of illustration and description. It is not intended to be exhaustive or to limit the invention to the precise for disclosed, and obviously many modifications and variations are possible in light of the above teaching. The described embodiments were chosen in order to best explain the principles of the invention and its practical application to thereby enable others skilled in the art to best utilize the invention in various embodiments, and with various modifications as are suited to the particular use contemplated. It is intended that the scope of the invention be defined by the claims appended hereto.

### DETAILED DESCRIPTION

BASECAM is a system that broadcasts video images from the bases used in the game of baseball. BASECAM takes an existing baseball base and turns it into a platform for one or more video cameras. The video images captured by BASECAM are transmitted by wireless signal to receivers placed off the field and out of view of the players or fans at a baseball game. These images are then inserted into the television or internet broadcast, by the existing television or internet production service, as either a live view or as an instant replay. The following procedure describes the assembly of one BASECAM with one camera. The same basic procedure applies to multi camera BASECAM assemblies.

To make one BASECAM system with one camera you need the following:
1. A professional quality baseball base, with a removable bottom base plate, equipped with a square tube mounting column.
2. A miniature video camera, a wireless transmitter and a wireless receiver. The transmitter and camera require battery power.
3. A small can of compressed air, not more than 1½″ in diameter or five inches in length.
4. A common R/F servo controlled valve, which fits the outlet of the compressed air canister and has at least one outlet.
5. Two feet of common flexible plastic tubing, ⅛″ ID.
6. One common double male 90-degree connector with two ⅛″ ID female connectors for the plastic hose.
7. A common R/F servo receiver with its' own power supply, and controller.
8. A 12″×12″ square piece of ¼″ foam rubber.
   Procedure:
1. Attach the plastic tubing to the 90-degree connector, this is the gas outlet (24).
2. Attach the gas outlet (24) to the edge of the camera lens barrel so the open end points toward the closest edge of the lens but does not interfere with the field of view of the lens. It is advisable to perform this step with the camera attached to its transmitter and a monitor to ensure the field of view is not obstructed. The male end of the nozzle should pass over the top of the camera body and the outlet should be attached to the camera body by a high quality fast setting glue or epoxy. See FIG. 1. Allow glue to dry completely.
3. Remove the bottom plate from the base.
4. Remove the rubber base cover, taking care not to tear the cover or the foam pad within.
5. In the center (lengthwise and widthwise) of one side of the rubber base cover (see FIG. 1) make a round hole just large enough to allow the camera lens only to pass through the hole. Due to the elastic quality of the rubber base cover, a punch of the proper size is a good way to make this hole. The diameter of the hole may be slightly smaller than the diameter of the outside of the camera lens, this makes for a tight fit when the camera is installed and helps prevent dirt or moisture from penetrating into the base interior.
6. Using sharp tools, remove just enough of the foam padding behind the hole drilled in step 4 to allow the rest of the camera body (24) to fit securely within the foam. To adjust the angle of view (up, down, right or left) of the camera change the shape of the rear wall of the hole you are making to force the camera to that angle when it is installed. A slight upward angle is desirable for maximum performance. It is advisable to have the camera active and monitor this angle while performing this procedure. By laying the foam pad on its bottom side one may judge the best viewing angle by having the camera active. Use the camera body as a guide for the exact shape and depth of this cavity. This cavity should conform in shape as precisely as possible to the camera body. When this step is complete, set the camera assembly aside and proceed to step 7.
7. Turn the foam padding upside down. Place the transmitter (12) on the padding away from the exact center of the base, allowing adequate space from where the edge of the mounting column (21) will be when the baseplate (20) is attached to the base. To ensure proper positioning of the transmitter (12) hold the baseplate (20) by the mounting column (21) and hold it over the foam padding, estimating the exact location of the baseplate when attached to the base. The transmitter should be placed away from the Camera (13) and the center of the foam padding, without covering the exact center of the foam padding and within reach of the cables leading from the camera. If the transmitter is equipped with an external antenna, position the antenna so the antenna is away from the body of the transmitter and does not come near the exact center of the foam padding. Using a suitable marking device trace the outside shape of the transmitter and its battery pack (if separate). Trace a separate channel for the antenna is so equipped. With a sharp tool cut the foam on the traced lines to a depth ¼″ deeper than the thickness of the transmitter. Remove the foam within this area only to the depth of the cut.
8. Slice a channel in the foam padding between the transmitter (12) and the Camera (13) large enough to allow the wires of the camera and the Gas Tube (25) to pass through to the transmitter cavity created in step 6.
9. Place the wires and Gas Tube (25) leading from the camera into the channel.
10. Gently pull both the plastic hose and the wires from the camera into the transmitter cavity (created in step 7) until the camera (13) fits snugly into the created in step 5. Make minor adjustments to the shape of this hole at this time, as needed, taking care not to remove too much of the padding. The camera must fit snugly into this hole and be at the proper angle for best viewing. If the camera is equipped with an external antenna position the antenna toward the outside of the base.
11. Using the same technique described in step 6, create a cavity and channel for the Servo Receiver (18) and it's power supply. This channel should lead back to the center of the base. Position the Servo Receiver on the opposite side of the base from the Transmitter (12). If the Servo Receiver has an external antenna position it toward the outside of the base.
12. Replace the base cover, taking care to fit the camera lens into the hole already cut in the cover (step 3). Make any minor adjustments to the shape of the hole to allow the air nozzle to pass comfortably through the hole. On the outside surface apply a sparing amount of silicon sealant (color can match base cover) between the outside edge of the camera lens housing and the base cover material to prevent dirt or moisture from getting inside the base. Take care not to allow the sealant to contact the camera lens or the gas outlet.
13. Attach the Servo Controlled Valve (19) to the Gas Cylinder (15). Wrap a small piece of foam rubber around the canister so the outside diameter of the canister (including the foam rubber) will fit snugly within the mounting column. The canister should move freely within the column when moderate pressure is applied but not slide downward under its own weight. Place the cylinder into the Mounting Column (21) so the valve is above the edge of the mounting column. Attach the lead wires from the Servo Receiver (18) to the Servo Controlled Valve (19). Turn the power switch on.
14. With the base upside down, attach the camera to the transmitter. Turn the power switch on. Neatly fold any excess wire and place transmitter into the transmitter cavity. Position the Gas Tube (25) so it continues past the Transmitter and goes to the center of the base. If an additional channel is needed to allow this make one now. Take a ¼″ thick piece of the foam rubber and cut it to the size of the transmitter cavity. Place over the transmitter and antenna; do not use any glue or sealant. A piece of common tape may be used to maintain the position of the foam rubber cover.
15. Holding the base plate by the mounting column, position it above the center of the base and estimate the needed length of the Gas Tube (25) so that it will connect comfortably to the Servo controlled valve. Cut the Gas Tube (25) to the desired length and attach it to the outlet of the Servo Controlled Valve (19). The length of the Gas Tube should be short enough to prevent crimping when the baseplate is attached to the base yet long enough to allow attachment to the valve. If needed, you may allow a few extra inches of tubing to facilitate the attachment. The gas cylinder may be pushed down into the column as the baseplate is lowered onto the base.
16. Lower the baseplate onto the base. Prior to attaching the baseplate, test both systems (video and compressed gas). Re-attach the baseplate with its screws.
17. Install the base on the field of play, into its mounting receptacle with the camera oriented toward the desired view.

BASECAM is now ready to use.

1. A system for using a baseball base with a camera during a baseball game, comprising: a baseball base having an outside surface and a viewport in a portion of said outside surface; a camera within said viewport pointed toward the field of play; and a transmitter connected to said camera and secured to said baseball base at a location other than said viewport.

2. A system according to claim 1, wherein: said viewport is at least partially filled with a vibration absorbing substance.

3. A system according to claim 1, wherein: said baseball base includes a shell and a pad inside said shell.

4. A system according to claim 1, wherein: said viewport is in said shell.

5. A system according to claim 1, further including: an antenna connected to said transmitter.

6. A system for using a baseball base with a camera during a baseball game, comprising: a baseball base having an outside surface and a viewport along a portion of said outside surface; a camera in said viewport; a transmitter connected to said camera.

7. A system according to claim 6, further including: a wire connecting said transmitter to said camera.

8. A system according to claim 6, wherein: said viewport is at least partially filled with a non-noisemaking, vibration absorbing substance.

9. A system for using a baseball base with a camera during a baseball game on a playing field, comprising: a baseball base having a visible outside surface and a bottom; a camera secured to said base such that said camera does not protrude from said visible outside surface; a transmitter inside said base, said transmitter connected to said camera.

10. A system according to claim 9, further including: an antenna, said antenna connected to said transmitter.

11. A system according to claim 9, further including: a conductor connecting said transmitter to said camera,

12. A system according to claim 1, wherein: said base includes a viewport along a portion of said visible outside surface; said camera is secured within said viewport; and said viewport is at least partially filled with a vibration absorbing substance.

13. A system according to claim 12, wherein: said baseball base includes a shell, a pad inside said shell and a baseplate; and said camera and transmitter are contained within said shell, pad and baseplate.

14. A system for using baseball bases with cameras during a baseball game on a playing field, comprising: a first baseball base having a first visible outside surface and a first bottom; a first camera secured to said first baseball base such that said first camera does not protrude from said first visible outside surface; a first transmitter inside said first base, said first transmitter connected to said first camera and at least one receiver; a second baseball base having a second visible outside surface and a second bottom; a second camera secured to said second baseball base such that said second camera does not protrude from said second visible outside surface; a second transmitter inside said second base, said second transmitter connected to said second camera and at least one receiver; a third baseball base having a third visible outside surface and a third bottom; a third camera secured to said third baseball base such that said third camera does not protrude from said third visible outside surface; a third transmitter inside said third base, said third transmitter connected to said third camera and at least one receiver.

15. A system according to claim 14, wherein: said first baseball base includes a first shell, a first viewport in said first shell, a first pad inside said first shell and a first baseplate; said first camera is secured within said first viewport; a system according to claim 14, wherein: said second baseball base includes a second shell, a second viewport in said second shell, a second pad inside said second shell and a second baseplate; said second camera is secured within said second viewport; a system according to claim 14, wherein: said third baseball base includes a third shell, a third viewport in said third shell, a third pad inside said third shell and a third baseplate; said third camera is secured within said third viewport;

16. A system according to claim 1, wherein compressed gas is used to clear the front of said camera of dirt or debris.

17. A system according to claim 16 further including a cylinder containing the compressed gas.

18. A system according to claim 16 further including a valve attached to said cylinder.

19. A system according to claim 16 further including a control mechanism attached to said valve.

20. A system according to claim 16 further including a transmitter which controls said mechanism attached to said valve.

21. A system according to claim 16 for delivering said compressed gas from said valve to said camera by plastic tubing.

22. A system according to claim 10 for directing said compressed gas onto the front of the lens of said camera.

23. A system according to claim 16 comprising a cylinder containing compressed gas, a valve attached to said cylinder, a control mechanism attached to said valve, a transmitter which controls said mechanism attached to said valve, plastic tubing attached to said valve which leads to the front of said camera and contained within said first baseplate and extending to said first camera by means of said plastic tubing and directed onto the front of said first camera lens.

24. A system according to claim 16 comprising a cylinder containing compressed gas, a valve attached to said cylinder, a control mechanism attached to said valve, a transmitter which controls said mechanism attached to said valve, plastic tubing attached to said valve which leads to the front of said camera and contained within said second baseplate and extending to said second camera by means of said plastic tubing and directed onto the front of said second camera lens.

25. A system according to claim 16 comprising a cylinder containing compressed gas, a valve attached to said cylinder, a control mechanism attached to said valve, a transmitter which controls said mechanism attached to said valve, plastic tubing attached to said valve which leads to the front of said camera and contained within said third baseplate and extending to said third camera by means of said plastic tubing and directed onto the front of said third camera lens.
